(19) United States
(12) Patent Application Publication
(10) Pub. No.: US 2011/0172102 A1
(43) Pub. Date: Jul. 14, 2011

(54) USE OF OLIGOAPIOGALACTURONANS AND THEIR DERIVATIVES TO SIMULATE DEFENCE AND RESISTANCE REACTIONS IN PLANTS AGAINST BIOTIC AND ABIOTIC STRESS SOURCES

(76) Inventors: Bruno Jacob, Trebeurden (FR); Jean-Francois Sassi, Ploubazlanec (FR); Hervé Le Deit, Lannion Servel (FR)

(21) Appl. No.: 13/058,431

(22) PCT Filed: Aug. 11, 2009
(86) PCT No.: PCT/EP2009/005815

§ 371 Date: Mar. 2, 2011

(30) Foreign Application Priority Data
Aug. 12, 2008 (FR) 0855529

(51) Int. Cl. A01N 43/16; C08B 37/06; A01P 21/00

(52) U.S. Cl. 504/292; 536/2

(57) ABSTRACT

The invention related to the use of oligo-apiogalacturonan compounds, particularly extracted from aquatic plants of the Lemna or Zostera Genus, as an agent for stimulating the defence and resistance reactions in a plant, in particular an ornamental plant or a plant of agricultural interest, against biotic an/or abiotic stresses. The invention further relates to a method for stimulating the natural defence reactions of a plant or a portion or a plant against biotic and/or abiotic stresses that includes applying at least one oligo-apiogalacturonan compound in a liquid or solid composition on said plant or a portion of a plant or in the environment of said plant.

The present invention concerns the use of oligoapiogalacturonan compounds as an agent for stimulating defence and resistance reactions in a plant, in particular an ornamental plant or plant or agronomic interest, against biotic and/or abiotic stress.

More specifically, the invention concerns the use of oligoapiogalacturonans extracted from at least one aquatic plant of the genus Zostera or Lemna, preferably from the species Zostera Marina, Zostera Noltii and Lemna Minor, and still more preferably from the species Zostera Marina and Zostera Noltii as an agent for simulating defence and resistance reactions in a plant against biotic and/or abiotic stress caused, for example, by an attack from pathogens.

In their environment, plants are continually subjected to stress or strains caused by external factors likely to affect their metabolism and trigger defence reactions within them. Such stress may be of biotic or abiotic origin. The stress is said to be of biotic origin when it originates from living organisms, for example from pathogenic micro-organisms such as fungi, bacteria, viruses, nematodes, insects or parasitic plants. The stress is said to be of abiotic origin when it results from a non-living source such as hydrous stress, oxidising stress, chemical stress or heat stress, Biotic and/or abiotic stress is the cause of significant economic losses for growers.

In order to combat these hostile influences, plants have, over the course of evolution, developed their own defence systems.

On one hand, there are “constitutive” defence mechanisms, that is, those permanently present within the plant. These protective mechanisms pass through the cell walls, waxes and cuticles that constitute natural physical barriers and thus prevent microbes from penetrating the plant tissue.

On the other hand, there are non-pre-existing defence mechanisms, known as “inducible” mechanisms. The introduction of these defence and resistance reactions by plants is in fact initiated by the perception of a biotic and/or abiotic stress source. The information is then relayed at intracellular level through a cascade of transduction signals that induce the expression of defence and resistance genes. For example, when a plant is attacked by a pathogenic agent, detection of this pathogenic agent and the induction of the plant's defence mechanisms may be initiated by recognition by the plant of chemical compounds that originate either from the pathogenic agent or from the plant itself.

Vegetable walls consist of parietal polysaccharides, the commonest of which are the pectins. When a plant is attacked by a pathogenic agent, this agent secretes enzymes capable of breaking down the polysaccharides in the vegetable wall. The products produced by disintegration of the wall can act as agents to stimulate the plant's defence reactions and are generally referred to as “elicitors”.

During a so-called “incompatible” reaction between plant and pathogen, in which the pathogen is identified rapidly and specifically by the plant according to a “gene for gene” relation, the defence reaction is singularly efficient. In fact, the interaction between the product of a resistance gene R carried by the plans and the product of a corresponding avirulence gene Avr (specific elicitor) carried by the pathogenic agent leads to the rapid activation of specific effective defence responses. The result of this interaction is most notably rapid necrosis of the plant cells at the site of the pathogen, a reaction referred to as hypersensitivity, and the aim of this is to confine the pathogen to the site and stop its progress throughout the plant.

During a so-called “compatible” reaction between plant and pathogen, the plant and/or the pathogen do not carry the resistance gene R and the avirulence gene Avr respectively. In this case, the plant's defence reactions may be brought about by the effects of wounds caused by the attack from the pathogen. For example, during a fungal attack, the oligosaccharides produced by the action of the fungal enzymes on the cell walls of the host plant on one hand and by the action of the plant hydrolases on the parietal polysaccharides of the pathogenic agent on the other hand may act as non-specific or general elicitors and trigger defence reactions in response to the attack from the pathogen. The defence reactions triggered are then late and/or weaker than the defence reactions that occur during an “incompatible” reaction between plant and pathogen and are non-specific. Symptoms and losses of yield remain moderate in a tolerant plant, while infestation will be severe and even fatal in a plant sensitive to this attack.

The defence reactions most commonly induced or stimulated in a plant during a pathogenic attach are programmed death of the cells at the pathogen penetration site (hypersensitivity response), reinforcement of the cell walls of the plant through the production of compounds such as lignine, callose or reticulation proteins, accumulation of anti-microbial compounds such as phytoalexin, synthesis of PR (pathogenesis-related) proteins such as chitinase, glucanase, peroxydase or enzyme inhibitors acting against the hydrolytic enzymes of the pathogenic agent.

It can be noted that the defence phenomena that accompany the hypersensitivity reaction can also be expressed during a compatible interaction.

Following an initial activation of the plant's defence mechanisms, chemical messengers can convey a defence signal to all the tissues in the plant, especially those not yet infested, and thus generate systemic resistance on the part of the plant. This phenomenon, known as “acquired systemic resistance” or ASR, helps increase the plant's resistance to subsequent attacks from pathogens.

Thus, with the aim of improving the methods of combating plant diseases caused by pathogens, one possible strategy involve the induction of defence reactions in the plant before a pathogen attacks it, through the external application of elicitor compounds. These elicitor compounds should preferably be sought for their natural origin, especially with the aim of limiting the use of pollutants.

Molecules capable of stimulating the defence mechanisms of plants in response to stress and thus increasing the plants' level of resistance are also known. These molecules may be of varying chemical nature, such as proteins, peptides, glycoproteins, lipids or oligosaccharides, and may be of varying origin, for example bacterial origin, such as harpine, vegetable origin such as oligogalacturonic acid, algal origin, such as laminarin, or synthetic origin, such as nicotinic acid derivatives. For example, the components of algal origin, a number of oligosaccharides such as laminarin, ulvanes, fucanes and carrageenans, are known for their capacity to stimulate certain defence mechanisms in plants to which they are applied.

However, a large number of these compounds have the drawback of being easily degradable within the environment of the plant, especially in soil, and have to be used in leaf applications only or applied repeatedly.

It is against this background, and in particular with the aim of enriching the collection of elicitor compounds of natural origin, that the research conducted by the applicant company has helped select compounds obtained from plants of aquatic origin and capable of stimulating defence and resistance reactions in a plant against biotic and/or abiotic stress, caused for example by an attack of pathogens.

The compounds identified can be used as a preventive treatment to stimulate or increase the effectiveness of defence mechanisms, for example according to the concentration used, or indeed as a curative treatment.

The compounds identified by the applicant company also have the advantage of degrading slowly in a land environment, especially in soil, thus making it possible to apply smaller quantities to the plants in relation to the compounds quoted. They also have the advantage of being particularly suitable for application to the root system, for example through nutrient solutions in an out-of-soil culture.

The present invention thus concerns the user of at least oligoapiogalacturonan consisting of 3-300 monosaccharide units, obtained in particular from aquatic plants of the Lemna or Zostera genus, as an agent for stimulating defence and resistance reactions in a plant or part of a plant, especially an ornamental plant or plant of agronomic interest, against biotic and/or abiotic stress.

Oligoapiogalacturonans trigger the activation of intracellular signal channels, which lead to the stimulation of defence and resistance genes and to the synthesis of compounds capable of combating the stress suffered by the plant.

The zosters, which are plants from the Zostera genus, belong to the family of Zosteraceae. The zosters are marine phanerogams that develop in sediments of sand and mud in intertidal and sub-littoral zones, within which they form occasionally dense submarine sea grasses. The zosters are structured with a more or less subterranean procumbent stem known as a rhizome, to which ribbon-shaped leaves are attached.

One biochemical characteristic of the Zostera genus of aquatic plants is that their cell walls contain specific types of polysaccharide, pectic substances or pectins known as apiogalacturonans. The chemical formula developed from this compound is illustrated. The apiogalacturonans from plants of the Zostera genus are known as zosterines or zosteranes.

The aquatic plants of the Lemna genus, or duckweeds, also contain apiogalacturonans in their cell walls. The apiogalacturonans from plants of the Lemna genus are known as lemnanes.

These specific pectic substances are macromolecules of a glucidic type consisting essentially of galacturonic acid. The skeleton of these molecules is formed through the linear chaining of an identical monomer motif alpha D-galacturonic acid. The motifs are interconnected by links α[1-4]. The particular feature of these pectins is the substitution of certain groups in the principal alpha D-galacturonic acid by monomer or dimer D-apiose motifs. Apiose (3-C-(hydroxymethyl)-D-glycero-tetrose), a rare sugar, is a branched chain pentose. The principal saccharide chain is also replaced with galactose, rhamnose, xylose and arabinose.

### Diagram of Zosterine

During its research, the applicant company observed that the presence of apiose motifs gave the oligoapiogalacturonans increased resistance when faced with the pectinolytic enzymes secreted by the micro-organisms and thus extended their life in a soil environment.

The use of oligoapiogalacturonan compounds, thus protected long-term against degradation by their apiose motifs helps optimise their efficacy in stimulating defence and resistance reactions by a plant against biotic and/or abiotic stress.

Without prejudging any particular mechanism of action, the presence of the apiose motifs thus gives the oligoapiogalacturonans increased levels of biological activity, suitable for application to plants with the aim of stimulating their defence and resistance reactions. The increased resistance of these compounds against biodegradation thus reduces the quantity of product to be applied and thus maximise the efficacy of the plant treatment. These compounds are particularly suitable for application to the root systems of targeted plants.

According to one method of realising the invention, the oligoapiogalacturonans in question are obtained from at least one aquatic plant of the Zostera or Lemna genus, preferably from the species Zostera Marina, Zostera Noltii and Lemna Minor, and still more preferably from the species Zostera Marina and Zostera Noltii.

The compounds according to the invention can be obtained by means of an extraction procedure comprising the following stages: a stage of washing the leaves and/or rhizomes of the plant, a grinding stage, and a stage of aqueous extraction of solid-liquid type, which may be followed by a stage of fractionation and concentration of the extract obtained.

According to one method of realising the invention, the oligapiogalacturonanes in question are obtained by enzymatic and/or chemical hydrolysis of an apiogalacturonane compound.

Preferably, these oligapiogalacturonanes consist of 3-100, and more preferably 3-30, units of monosaccharide.

According to another method of realising the invention, the said oligapiogalacturonanes are obtained by grafting of apiose motifs onto oligogalacturonan compounds.

Advantageously, each oligapiogalacturonan contains at least 5% and preferably 10-80% apiose motifs, and more preferably 20-70% of apiose motifs.

The apiogalacturonans obtained from plants of the Lemna Minor species contain 64% alpha D-galacturonic acid and 25% D-apiose. These are therefore the compounds of choice for the invention for the purpose of obtaining the oligoapiogalacturonans used in the present invention.

According to one characteristic of the invention, the said oligoapiogalacturonans are applied to the said plant or part thereof in a quantity between 0.01 and 100 g/l in liquid form via the foliar system, the root system or the grain or environment of the said plant, most notably within a nutrient solution intended for a hydroponic type of culture, or in a quantity between 0.01 and 100 g/kg in solid form in the environment of the said plant, before or after planting or harvesting of the plant.

Application to the plants may thus be made by means of a solid composition, such as a rod or granule that can, for example, be placed in the soil in which the plant is placed. Application may also be made by pulverisation on the plant or part thereof, or by watering at the foot of the plant with a solution containing the compounds of interest. In addition, application may also be made on the plant after harvesting.

In the case of a hydroponic culture, application may be made through a nutrient solution provided for the purpose.

According to the invention, the term “plant” indicates any items of vegetation, especially of the monocotyledonous or dicotyledonous gymnosperm or angiosperm type, especially any plant of ornamental or agronomic type, regardless of its stage of development.

The term “part of plant” or “part thereof” indicates any fragment of a plant containing at least one plant cell, such as a plant organ such as a leaf, bud, flower, root, fruit or grain, or a plant tissue such as a meristem, callus or plant cell.

According to a preferred method of realising the invention, the use of oligoapiogalacturonans lies in the stimulation of defence reactions against pathogens.

The invention also relates to a process of stimulating the natural defence and resistance reactions of a plant or part thereof against biotic and/or abiotic stress, characterised in that it includes the application, to the said plant or part thereof or in the environment of the plant, of at least one oligoapiogalacturonan, including 3-300 monosaccharide units, in liquid form or solid form.

Preferably, the quantity of oligoapiogalacturonans should be between 0.01 and 100 g/l in a liquid composition and between 0.01 and 100 g/kg in a solid composition.

The invention also relates to a product for stimulating natural defence and resistance reactions in a plant or part thereof against biotic and/or abiotic stress, characterised in that it consists of at least one oligoapiogalacturonan containing 3-300 monosaccharide units.

According to one method of realisation, the said oligoapiogalacturonans are extracted from at least one aquatic plant of the genus Zostera and/or Lemna, preferably from the species Zostera Marina, Zostera Noltii and Lemna Minor, and more preferably from the species Zostera Marina and Zostera Noltii.

According to one specific method of realising the invention, such a product also contains p-sulphoxy-cinnamic acid or zosteric acid.

This method of realisation is particularly advantageous, as zosteric acid prevents the adhesion of micro-organisms to the surface of plants.

The product according to the invention may take the form of a solution, emulsion, powder, granule or coating solution, especially a grain coating solution.

Advantageously, the product according to the invention contains between 0.01 and 100 g/l of at least one oligoapiogalacturonan, when the said product is in liquid form, or between 0.01 and 100 g/kg of at least one apiogalacturonane compound and/or apiogalacturonane compound derivative when the said product is in solid form.

According to another method of realisation, the product according to the invention also contains at least one fertiliser.

According to another method of realisation, the product according to the invention also contains at least one phytosanitary product and preferably at least one elicitor product.

Fertilisers likely to be used in a product according to the invention may include urea, ammonium sulphate, ammonium nitrate, natural phosphorus, potassium chloride, ammonium sulphate, magnesium nitrate, manganese nitrate, zinc nitrate, copper nitrate, phosphoric acid, boric acid and NP, PK and NPK types of fertiliser.

The characteristics of the invention mentioned above, and others, will become clearer in a reading of the following description of one example of realising the invention.

Procedure for Preparing an Extract of Apiogalacturonane Compounds from a Plant from the Family Zosteraceae

Harvesting and grinding of plant matter: Beached zoster plants from the species Zostera Noltii were harvested in August 2003 from the Arcachon Basin in the Andernos Sector, Gironde, France. The plant material was initially dried in open air on the spreading site, then washed in soft water, and finally dried at 50° C. until a constant mass was obtained. The material was then reduced to a powder with average granule measurement in the region of 100 mcm.

Leaching of zoster plant: In a 250-ml balloon, the previously cleaned zoster (8 g) is added to 72 ml of distilled water. The pH is adjusted to 4 through the addition of 3N hydrochloric acid solution. The milieu is kept stirred for 3 hours at a temperature of 50° C. After return to ambient temperature, the reactive milieu is filtered through sintered glass (porosity 15-50 mcm). The filtrate is then dialysed for one might using a cellulose membrane, in order to remove chloride anions with a view to analysis. The retentate is used directly during the following stage.

Extraction of zosterine (zoster apiogalacturonane): In a 250-ml balloon, the leached zoster previously obtained is added to 80 ml of 1% aqueous ammonium oxalate solution. The milieu is stirred and kept at a temperature of 70° C. for 4 hours. After return to ambient temperature, the phases are separated by means of centrifuging (20 minutes; 15° C.; 15,000 g). The liquid phase is preserved and the solid phase subjected to a second ammonium oxalate extraction (200 ml). After separation, the liquid phases are brought back together. The volume is reduced using a rotating evaporator until the first zosterine molecules precipitate. The milieu is then transferred to a 500-ml beaker in which the zosterine is precipitated through the addition of 200 ml (3 volumes) of ethanol. The zosterine is recovered after centrifuging (20 minutes; 15° C.; 3000 g). The zosterine is then solubilised in water, dialysed through a 10-KD membrane and then lyophilised. This allows isolation of 1.2 g of zosterine, corresponding to an extraction yield of 15% in relation to the zoster extracted.

This method produces zosterine termed LJ1. It is brownish in colour, containing 2.7% of polyphenols.

Zosterine LJ1 can then be purified by using a hydrophobic resin such as Amberlite™ XAD™ 16 (marketed by Rohm and Haas) with a yield of 63%. This produces zosterine LJ2, white in colour, with a total monosaccharide content of 63%. This zosterine contains no more than 0.5% of polyphenols.

Purification of zosterine on resin: In a 250-ml Erlenmeyer flask, the zosterine (400 mg) is solubilised in 74 ml of water at 50° C. After solubilisation, the Amberlite™ XAD™ 16 resin (30 g) is added to the milieu. The milieu is then stirred and kept at a temperature of 50° C. for one night. The resin is removed by filtration on sintered glass under atmospheric pressure. The filtrate is concentrated until precipitation occurs. The zosterine precipitates through addition of three volumes of ethanol. The zosterine is then filtered using Buchner, dialysed on a 10-LD membrane and then lyophilised.

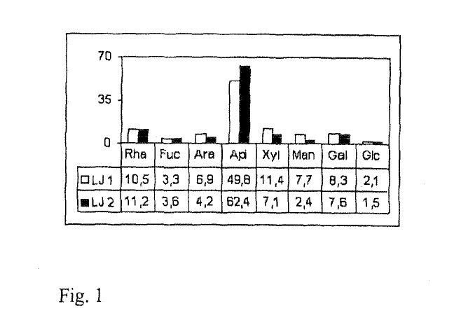

The neutral monosaccharide composition of the two zosterines LJ1 and LJ2 is given in FIG. 1, illustrating the neutral monosaccharide composition of zosterines LJ1 and LJ2 obtained from Zostera Noltii, expressed as a percentage.

In FIG. 1 Rha=Rhamnose, Fuc=fucose, Ara=arabinose, Api=apiose, Xyl=xylose, Man=manose, Gal=galactose, Glc=glucose.

Extraction procedures involving enzymes or apiogalacturonane compound acid can also be envisaged.

### Preparation of the Oligoapiogalacturonans

The zosterines LJ1 and LJ2 are hydrolysed using enzymes in order to obtain oligoapiogalacturonans containing 3-300 saccharide units, respectively LJ′1 and LJ′2.

To do this, 54 mg of apiogalacturonane extracted according to the previous sample are solubilised in 4 g of demineralised water. The pH is adjusted to 5 using a sodium acetate/acetic acid buffer. 1 ml of demineralised water containing 5.4 mg of pectinase obtained from Aspergillus Niger at 1.8 U/mg (supplied by Fluka) is added and the milieu is homogenised by means of stirring, then kept incubated at 40° C. while being stirred, for 3 hours 30 minutes. The reaction mixture is then brought to boiling point to deactivate the enzyme. One denatured, the enzyme precipitates and is separated by centrifuging. The centrifuging supernatant is collected and desalted by dialysis through a membrane with a cutting limit of 1000 Da. The dialysis retentate is frozen and dried by lyophilisation. The average level of polymerisation by numbers of the oligoapiogalacturonan obtained is 27.

Procedures for preparing oligoapiogalacturonans from other enzymes and/or chemical auxiliaries can also be envisaged.

Preparation of Products for Stimulating Defence Reactions in a Plant or Part Thereof Against Biotic and/or Abiotic Stress

Various products have been prepared using an extract as obtained previously. In this example, the extract used is purified on resin and corresponds to LJ′2, The use of LJ′1 is not excluded.

Liquid compositions have been prepared by mixing an extract obtained by a procedure as described above with zosteric acid. The liquid compositions contain between 0.2 and 2 g/l of apiogalacturonane compounds and 10 g/l of zosteric acid. These solutions can be pulverised directly onto plant leaves.

Other liquid compositions have been prepared by adding an extract obtained via a procedure as described above to a NPK-type fertiliser solution. The solutions contain 0.2 and 2 g/l of apiogalacturonane compounds. Such solutions may be applied to the root systems of plants by means of watering.

Compositions for coating plant grains have been prepared by including 2 g/l of an extract obtained using a procedure as described above in a coating composition known to specialists in the field, for example a hemi-cellulose-based coating composition. Plant grains may also be coated with such a composition.

1. Use of at least one oligoapiogalacturonan containing 3-300 monosaccharide units as an agent for stimulating defence and resistance reactions in a plant or part thereof, in particular an ornamental plant or plant of agronomic interest, against biotic and/or abiotic stress.

2. Use as per claim 1, characterised in that the said oligoapiogalacturonans are extracted from leaves and/or rhizomes of at least one aquatic plant of the genus Zostera or Lemna, preferably from the species Zostera Marina, Zostera Noltii and Lemna Minor, and more preferably from the species Zostera Marina and Zostera Noltii.

3. Use as per claim 1, characterised in that the said oligoapiogalacturonans consist of 3-100 monosaccharide units and preferably 3-30 monosaccharide units.

4. Use as per claim 1, characterised in that the said oligoapiogalacturonans are obtained by enzyme and/or chemical hydrolysis of an apiogalacturonane compound.

5. Use as per claim 1, characterised in that each oligoapiogalacturonan compound contains at least 5%, preferably 10-80% and more preferably 20-70% D-apiose motifs.

6. Use as per claim 1, characterised in that the said oligoapiogalacturonans are applied to the said plant or part thereof in a quantity between 0.01 and 100 g/l in liquid form via the foliar system, root system or grain or environment of the said plant, especially in a nutrient solution intended for a hydroponic culture, or in a quantity between 0.01 and 100 g/kg in solid form within the environment of the said plant, before or after its planting or harvesting.

7. Use as per claim 1, characterised in that it involves the stimulation of defence reactions against pathogens.

8. Procedure for stimulating natural defence reactions in a plant or part thereof against biotic and/or abiotic stress, characterised in that it comprises the application, to the said plant or part thereof or in its environment, of at least one oligoapiogalacturonan compound containing 3-300, preferably 3-100 and more preferably 3-30 monosaccharide units, within a solid or liquid composition.

9. Procedure as per claim 8, characterised in that the quantity of oligoapiogalacturonan compound is between 0.01 and 100 g/l in a liquid composition and between 0.01 and 100 g/kg in a solid composition.

10. Product for stimulating the natural defence and resistance reactions of a plant or part thereof against biotic or abiotic stress, characterised in that it contains at least one oligoapiogalacturonan compound containing 3-300, preferably 3-100 and more preferably 3-30 monosaccharide units.

11. Product as per claim 10, characterised in that the said oligoapiogalacturonans are extracted from at least one aquatic plant of the genus Zostera or Lemna, preferably from the species Zostera Marina, Zostera Noltii and Lemna Minor, and more preferably from the species Zostera Marina and Zostera Noltii.

12. Product as per claim 10, characterised in that it also contains p-sulphoxy-cinnamic acid.

13. Product as per claim 10, characterised in that it takes the form of a solution, emulsion, powder, granule, rod or coating composition.

14. Product as per claim 10, characterised in that it contains between 0.01 and 100 g/l of at least one oligoapiogalacturonan compound when the said product is in liquid form or between 0.01 and 100 g/kg of at least one oligoapiogalacturonan compound when the said product is in solid form.

15. Product according to claim 10, characterised in that it also contains one or more fertilisers, one or more phytosanitary products, preferably one or more elicitor products, or a mixture.
